(19) United States
(12) Patent Application Publication
(10) Pub. No.: US 2025/0325860 A1
(43) Pub. Date: Oct. 23, 2025

(54) Forest Fire Extinguishing Agent and Preparation Method Therefor

(71) Applicant: BEIJING WEIDE AIKE BIOTECHNOLOGY RESEARCH INSTITUTE CO., LTD., Beijing (CN)

(72) Inventor: Weide Zhong, Beijing (CN)

(73) Assignee: BEIJING WEIDE AIKE BIOTECHNOLOGY RESEARCH INSTITUTE CO., LTD., Beijing (CN)

(21) Appl. No.: 19/259,800

(22) Filed: Jul. 3, 2025

Related U.S. Application Data
(63) Continuation of application No. PCT/CN2025/081517, filed on Mar. 10, 2025.

(30) Foreign Application Priority Data
Apr. 7, 2024 (CN) 202410409761.6

(51) Int. Cl. A62D 1/00; B01J 13/16

(52) U.S. Cl. CPC A62D 1/0021; B01J 13/16

(57) ABSTRACT

The present application provides a forest fire extinguishing agent and a preparation method therefor. The method comprises the following steps: mixing a first flame retardant and a coupling agent uniformly to obtain a first material; stirring a hydrophobic polymer monomer or a hydrophobic polymer monomer and an initiator into the first material to obtain a second material; stirring a surfactant into the second material to obtain a mixture before heating the mixture to obtain a third material; obtaining a fourth material by adding a solution comprising a hydrophilic polymer and water to the third material, applying a homogenization treatment to the third material with the solution added, heating and stirring the third material with the solution added, and letting the third material and the solution react under a constant temperature; and stirring a flame retardant additive and water to the fourth material to obtain the forest fire extinguishing agent.

### CROSS REFERENCE TO RELATED APPLICATIONS

This application is a continuation of PCT Patent Application No. PCT/CN2025/081517, filed on Mar. 10, 2025, which claims priority to Chinese Patent Application No. 202410409761.6, filed on Apr. 7, 2024, and entitled “FOREST FIRE EXTINGUISHING AGENT AND PREPARATION METHOD THEREFOR”, the disclosures of which are hereby incorporated by reference in their entirety.

### TECHNICAL FIELD

The present application belongs to the technical field of fire extinguishing agents, and in particular, relates to a forest fire extinguishing agent and a preparation method therefor.

### BACKGROUND

Forest fires occur every year, often causing serious ecological disasters and significant losses of personnel and properties. There are many kinds of fire extinguishing agents, but the commonly used dry powder extinguishing agents, foam extinguishing agents and gas extinguishing agents are not suitable for extinguishing forest and grassland fires. Due to intense airflow activities in fire areas, it is difficult for the aforementioned fire extinguishing agents to land on combustibles.

Water is the cheapest fire extinguishing agent, but its efficiency in extinguishing forest fires is very low, and its function is to lower the surface temperature of combustibles. Forest fires have the characteristics of large range, high temperature, and high intensity, so it is difficult to extinguish forest fires with a little water.

At present, forest fire extinguishing agents containing halogens such as “halon” are commonly used, but the halogen-based fire extinguishing agents release toxic substances at high temperatures to seriously pollute the environment.

### SUMMARY

The present application provides a forest fire extinguishing agent and a preparation method therefor to solve the problem that existing halogen-based fire extinguishing agents release toxic substances at high temperatures to seriously pollute the environment.

To achieve the above objective, a first aspect of the present application discloses a method for preparing a forest fire extinguishing agent, including the following steps:
(1) mixing a first flame retardant and a coupling agent uniformly to obtain a first material;
(2) stirring a hydrophobic polymer monomer or a hydrophobic polymer monomer and an initiator into the first material uniformly to obtain a second material;
(3) stirring a surfactant into the second material to obtain a mixture before heating the mixture to obtain a third material;
(4) obtaining a fourth material by adding a solution including a hydrophilic polymer and water to the third material, applying a homogenization treatment to the third material with the solution added, heating and stirring the third material with the solution added, and letting the third material and the solution react under a constant temperature; and
(5) cooling the fourth material before stirring a flame retardant additive and water uniformly into the fourth material to obtain the forest fire extinguishing agent.

The first flame retardant is at least one of a guanidine salt flame retardant, an ammonium salt flame retardant, or a phosphorus-based flame retardant.

In an example of the present application, the dosage of the guanidine salt flame retardant is 5-30 parts by weight, the dosage of the phosphorus-based flame retardant is 5-35 parts by weight, and the dosage of the ammonium salt flame retardant is 5-25 parts by weight.

In the present application, various flame retardants are first subjected to surface modification treatment with the coupling agent, and then the modified flame retardants are coated with the hydrophobic polymer monomer and polymerized in situ under the action of the hydrophilic polymer to form a coated body with a core-shell structure, so as to prepare an efficient and environment-friendly water-based forest fire extinguishing agent. The forest fire extinguishing agent can be quickly dispersed in water. After diluted 10-20 times with water, its fire extinguishing effect can reach the “2A” high-efficiency standard. The forest fire extinguishing agent is easy to use, produces no toxic substances at high temperatures, has no impact on the ecology of forest areas, and is efficient and environment-friendly.

The guanidine salt flame retardant is non-toxic, efficient, environment-friendly, and safe, and is a main agent for extinguishing forest fires. Its natural degradation rate is high. At high temperatures, guanidine decomposes into nitrogen, water, and urea, which can dilute oxygen, quickly reduce the oxygen content of air, and cover and block combustibles to extinguish fires. The ammonium salt flame retardant is non-toxic, efficient, environment-friendly, and safe, has an obvious flame retarding effect, and is a conventional main flame retardant.

In the present application, the guanidine salt flame retardant and the ammonium salt flame retardant are combined to fully exert their synergistic effect.

Further, in step (1), the dosage of the guanidine salt flame retardant is 5-30 parts by weight, and the dosage of the ammonium salt flame retardant is 5-25 parts by weight. In examples, the guanidine salt flame retardant is selected from one or more of a polymeric guanidine, a guanidine carbonate, a guanidine nitrate, a guanidine acetate, a guanidine phosphate, a guanidine borate, a guanidine sulfate, a guanidine oxalate, or a guanidine benzoate. In examples, the guanidine salt flame retardant is selected from one or more of a guanidine carbonate, a guanidine phosphate, or a guanidine borate. The ammonium salt flame retardant is selected from one or more of an ammonium sulfate, an ammonium carbonate, an ammonium phosphate, an ammonium dihydrogen phosphate, an ammonium bicarbonate, or an ammonium polyphosphate. In examples, the ammonium salt flame retardant is selected from one or more of an ammonium phosphate, an ammonium dihydrogen phosphate, or an ammonium polyphosphate.

In an example of the present application, in step (2), the initiator is added to an oil-based carrier to obtain a mixture, which is then added to the first material, where the oil-based carrier is selected from at least one of mineral oil, petroleum ether, or paraffin.

In order to further improve the flame retarding effect, a second flame retardant is added to a reaction product of the third material and the solution in step (4), and the second flame retardant is a metal hydroxide flame retardant, with a dosage of 2-15 parts by weight.

The metal hydroxide flame retardant decomposes into a large amount of water and metal oxides at high temperatures. The water can rapidly lower the surface temperature of combustibles, while the metal oxides can cover the surfaces of the combustibles to block oxidation reactions. The generated metal oxides can not only block the oxidation reaction of the combustibles at high temperatures, but also eliminate smoke and improve the transparency of air in fire areas.

The phosphorus-based flame retardants decompose upon heating to produce acids such as a phosphoric acid, a polymetaphosphoric acid, and a metaphosphoric acid, which have strong dehydrating effects. These acids rapidly dehydrate and carbonize the surfaces of plants to form dense phosphorus-containing carbonized layers, so as to block oxidation reaction, absorb oxidation heat energy on the surfaces of combustibles, and isolate air and heat sources.

In examples, the metal hydroxide is selected from one or more of a magnesium hydroxide, an iron hydroxide, an aluminum hydroxide, a calcium hydroxide, or a zinc oxide. In examples, the metal hydroxide is selected from one or more of an aluminum hydroxide, a calcium hydroxide, or a magnesium hydroxide.

In examples, the phosphorus-based flame retardant is selected from one or more of a coated red phosphorus, a phosphate ester, a methyl phosphate, an ethyl phosphate, a butyl phosphate, a zinc phosphate, an isooctyl phosphate, an isopropyl triphenyl phosphate, a phenyl phosphate, or a dimethyl methylphosphate. In examples, the phosphorus-based flame retardant is selected from one or more of a coated red phosphorus, an isooctyl phosphate, or an isopropyl triphenyl phosphate.

Further, the coupling agent is selected from one or more of a tetrabutyl titanate, an aluminate ester, a silane coupling agent, a phosphate coupling agent, or a borate coupling agent, and the dosage of the coupling agent is 0.1-5.0 parts by weight. The silane coupling agent may be selected from KH550, KH560, KH570, or KH792. In examples, the coupling agent is selected from one or more of a silane coupling agent or a tetrabutyl titanate.

A solvent for dissolving the coupling agent is selected from one or more of an ethanol, a methanol, a butanol, an acetone, a dimethylformamide, a dichloromethane, or a trichloromethane. In examples, the solvent is selected from one or more of an ethanol, an acetone, or a dichloromethane. The dosage of the solvent is 1-10 parts by weight.

Further, the hydrophobic polymer monomer is selected from one or more of a methyl acrylate, an ethyl acrylate, a butyl acrylate, a glycidyl methacrylate, a 1,4-butanediol dimethacrylate, a methyl methacrylate, an ethyl acetoacetate methacrylate, an isophorone diisocyanate, or a toluene diisocyanate, and the dosage of the hydrophobic polymer monomer is 0.5-20 parts by weight; the initiator is selected from one or more of an azobisisobutyronitrile, a potassium persulfate, an ammonium persulfate, or a benzoyl peroxide (e.g., the initiator may be selected from one or more of an azobisisobutyronitrile or a potassium persulfate). A mass ratio of the initiator to the hydrophobic polymer monomer is 0.01% to 5.00%. The surfactant is selected from one or more of a propylene glycol monolaurate, a sorbitan monostearate, a polyoxyethylene sorbitan monooleate, a sorbitan monolaurate, a sodium dodecyl sulfate, a sodium dodecyl benzene sulfonate, a diethylene glycol fatty acid ester, a sorbitan monopalmitate, a polyoxyethylene stearate, a polyoxyethylene sorbitan trioleate, or a sorbitan monooleate polyoxyethylene ether, and a ratio of the surfactant to the hydrophobic polymer monomer is (0.2-50): 100; the hydrophilic polymer is selected from one or more of a polyvinyl alcohol, a polyethylene glycol, an acrylamide, a N-hydroxymethyl acrylamide, a N-hydroxyethyl acrylamide, an acrylonitrile, or a diethylenetriamine, and the dosage of the hydrophilic polymer is 0.1-10 parts by weight.

In order to coat the surface of the flame retardant more uniformly with the hydrophobic polymer monomer, a hydrophobic ester may be used as a diluent or solvent in step (2).

Further, in step (4), a duration of the homogenization treatment is 1-60 minutes (e.g., 10-30 minutes), the constant temperature for the reaction is 45 DEG C.-90 DEG C. (e.g., 45 DEG C.-80 DEG C.), and a duration of the reaction is 0.5-8.0 hours (e.g., 1-3 hours).

Further, the flame retardant additive is selected from one or more of a silica nanopowder, an ammonium polyphosphate, a sodium silicate, a silica sol, an aluminum hydroxide, or an ammonium dihydrogen phosphate. The dosage of the flame retardant additive is 1-10 parts by weight.

To achieve the above objective, a second aspect of the present application discloses a forest fire extinguishing agent prepared by the preparation method in the first aspect.

To achieve the above objective, a third aspect of the present application discloses a forest fire extinguishing agent, including a flame retardant with a core-shell structure, and a carrier, where

in the flame retardant with the core-shell structure, a core of the core-shell structure includes a first flame retardant, a shell of the core-shell structure includes a water absorbent polymer, and the first flame retardant is at least one of a guanidine salt flame retardant, an ammonium salt flame retardant, or a phosphorus-based flame retardant; and where the shell of the core-shell structure further includes a metal hydroxide flame retardant.

Further, the carrier is water.

Further, the carrier is a solution or mixture including water and a flame retardant additive.

Further, the flame retardant additive is selected from one or more of a silica nanopowder, an ammonium polyphosphate, a sodium silicate, a silica sol, an aluminum hydroxide, or an ammonium dihydrogen phosphate.

According to the method for preparing the forest fire extinguishing agent provided in the present application, the flame retardant is first subjected to surface modification treatment with the coupling agent, and then the modified flame retardant is coated with the hydrophobic polymer monomer and polymerized in situ under the action of the hydrophilic polymer to form a coated body with a core-shell structure, where the coated body has a diameter from several micrometers to tens of micrometers and can be quickly dispersed and suspended in water. After diluted 10-20 times with water, its fire extinguishing can effect reach the 2A level of “National Standard GB17835-2008. Water-Based Fire Extinguishing Agents”. The forest fire extinguishing agent is easy to use, produces no toxic substances at high temperatures, has no impact on the ecology of forest areas, and is efficient and environment-friendly.

### BRIEF DESCRIPTION OF DRAWINGS

In order to describe the technical solutions in the examples of the present application or in the prior art more clearly, a brief introduction for the drawings required in the description for the examples or the prior art will be provided below, apparently, the drawings in the description below show merely some examples of the present application, and those of ordinary skill in the art may also derive other drawings from these drawings without making creative efforts.

FIG. 1 is a schematic structural diagram of a paper strip used in flame retarding effect test.

### DETAILED DESCRIPTION

In order to make the objectives, technical solutions, and advantages of the examples of the present application clearer, the technical solutions in the examples of the present application are clearly and completely described below in combination with the drawings in the examples of the present application, and apparently, the examples described are merely a part rather than all of the examples of the present application. On the basis of the examples in the present application, all other examples obtained by those of ordinary skill in the art without creative efforts shall fall within the protection scope of the present application.

The present application provides a forest fire extinguishing agent and a preparation method therefor. In the present application, unless otherwise specified, all raw materials are commercially available products well known to those skilled in the art.

### Example 1

(1) 150 g of guanidine borate powder and 150 g of ammonium polyphosphate were weighed and pre-mixed in a sand mill mixer for 1 hour. 15 g of silane coupling agent kH570 was weighed and dissolved in 80 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material.

(2) 8 g of methyl methacrylate and 8 g of 1,4-butanediol dimethacrylate were weighed and stirred uniformly into the first material, and a solution including 0.2 g of azobisisobutyronitrile and 20 g of mineral oil was further added to the first material to obtain a mixture, which was then heated to 40 DEG C. and continuously stirred for 20 minutes to obtain a second material.

(3) 8 g of sorbitan monooleate polyoxyethylene ether was weighed and added to the second material while stirring to obtain a mixture, which was then mixed well, heated to 50 DEG C., and stirred for 20 minutes to obtain a third material.

(4) 4 g of N-hydroxyethyl acrylamide was weighed and dissolved in 400 ml (60 DEG C.) deionized water to obtain a solution, the solution was added to the third material to obtain a mixture, which was then homogenized for 10 minutes and reacted at a constant temperature of 60 DEG C. for 4 hours to obtain a fourth material.

(5) The fourth material was cooled to 45 DEG C., added with 50 g of silica sol, supplemented with deionized water until 1000 g, and stirred for 10 minutes to obtain a forest fire extinguishing agent.

### Example 2

(1) 150 g of guanidine carbonate and 100 g of ammonium polyphosphate were weighed and pre-mixed in a sand mill mixer for 1 hour. 25 g of silane coupling agent kH550 was weighed and dissolved in 100 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material.

(2) 80 g of glycidyl methacrylate was weighed and mixed to the first material uniformly, and a solution including 1 g of dibenzoyl oxide and 20 g of mineral oil was further added to the first material to obtain a mixture, which was then heated to 50 DEG C and continuously stirred for 20 minutes to obtain a second material.

(3) 10 g of sodium dodecyl sulfate was weighed and added to the second material while stirring to obtain a mixture, which was then mixed well, heated to 50 DEG C, and stirred for 20 minutes to obtain a third material.

(4) 50 g of acrylonitrile, 100 g of aluminum hydroxide, and 5 g of sodium carboxymethyl cellulose were weighed and dissolved in 400 ml (60 DEG C.) of deionized water to obtain a solution, the solution was added to the third material to obtain a mixture, which was then homogenized for 10 minutes and reacted at a constant temperature of 60 DEG C. for 4 hours to obtain a fourth material.

(5) The fourth material was cooled to room temperature, added with 40 g of silica nanopowder, supplemented with deionized water until 1000 g, and stirred for 10 minutes to obtain a forest fire extinguishing agent.

### Example 3

(1) 150 g of guanidine carbonate and 100 g of ammonium polyphosphate were weighed and pre-mixed in a sand mill mixer for 1 hour. 25 g of silane coupling agent kH550 was weighed and dissolved in 100 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material.

(2) 80 g of glycidyl methacrylate was weighed and mixed to the first material uniformly, and a solution including 1 g of dibenzoyl oxide and 20 g of mineral oil was further added to the first material to obtain a mixture, which was then heated to 50 DEG C and continuously stirred for 20 minutes to obtain a second material.

(3) 10 g of sodium dodecyl sulfate was weighed and added to the second material while stirring to obtain a mixture, which was then mixed well, heated to 50 DEG C, and stirred for 20 minutes to obtain a third material.

(4) 50 g of acrylonitrile, 100 g of magnesium hydroxide, and 5 g of sodium carboxymethyl cellulose was weighed and dissolved in 400 ml (60 DEG C.) of deionized water to obtain a solution, and the solution was added to the third material to obtain a mixture, which was then homogenized for 10 minutes and reacted at a constant temperature of 60 DEG C. for 4 hours to obtain a fourth material.

(5) The fourth material was cooled to room temperature, added with 40 g of silica nanopowder, supplemented with deionized water until 1000 g, and stirred for 10 minutes to obtain a forest fire extinguishing agent.

### Example 4

(1) 150 g of ammonium polyphosphate with a polymerization degree n>25 and 50 g of guanidine phosphate were weighed and pre-mixed in a sand mill for 1 hour. 15 g of silane coupling agent KH550 was weighed and dissolved in 85 ml of anhydrous ethanol to obtain a solution, which was then dripped into a stirred flame retardant powder for 30 minutes. A sand mill heater was started, and the system was maintained at a constant temperature of 60 DEG C. and continuously stirred for 40 minutes to evaporate the solvent and obtain a modified first material.

(2) 8 g of methyl methacrylate and 4 g of ethyl acetoacetate methacrylate were weighed and mixed to the first material uniformly, 0.2 g of azobisisobutyronitrile and 30 g of petroleum ether were further mixed uniformly to obtain a mixture, which was further added to the first material, and the first material added with the mixture was heated to 40 DEG C. and stirred well to obtain a second material.

(3) 8 g of sorbitan monooleate polyoxyethylene ether was weighed, mixed, heated to 50 DEG C., and added to the second material while stirring to obtain a mixture, which was then continuously stirred for 20 minutes to obtain a third material.

(4) 20 g of diethylenetriamine, 150 g of aluminum hydroxide, and 10 g of sodium carboxymethyl cellulose were weighed and dissolved in 400 ml (60 DEG C.) of deionized water to obtain a solution, and the solution was added to the third material to obtain a mixture, which was then homogenized for 30 minutes and reacted at a constant temperature of 70 DEG C. for 3 hours to obtain a fourth material.

(5) The fourth material was cooled to 45 DEG C., added with 50 g of ammonium dihydrogen phosphate, supplemented with deionized water until 1000 g, and stirred for 10 minutes to obtain a forest fire extinguishing agent.

### Example 5

(1) 100 g of polymeric guanidine, 150 g of ammonium polyphosphate powder, and 100 g of isopropyl triphenyl phosphate were weighed and pre-mixed in a sand mill for 1 hour. A solution including 15 g of silane coupling agent KH550 and 80 ml of anhydrous ethanol was dripped into a stirred flame retardant for 30 minutes, a sand mill heater was started, and the system was maintained at a constant temperature of 60 DEG C. and continuously stirred for 40 minutes to evaporate the solvent and obtain a modified first material.

(2) 40 g of isophorone diisocyanate was weighed and added to the first material to obtain a mixture, which was then stirred well, added with 10 ml of mineral oil, heated to 40 DEG C., and further stirred well to obtain a second material.

(3) 3 g of sorbitan monopalmitate was weighed, mixed, heated to 50 DEG C., stirred for 10 minutes, and added to the second material to obtain a mixture, which was then stirred well to obtain a third material.

(4) 20 g of diethylenetriamine and 50 g of aluminum hydroxide were weighed and dispersed in 400 ml (60 DEG C.) deionized water to obtain a solution, and the solution was added to the third material to obtain a mixture, which was then homogenized for 20 minutes and reacted at a constant temperature of 65 DEG C. for 2.5 hours to obtain a fourth material.

(5) The fourth material was cooled to 45 DEG C., added with 50 g of silica sol, supplemented with deionized water until 1000 g, and stirred for 10 minutes to obtain a forest fire extinguishing agent.

### Comparative Example 1: (Ammonium Polyphosphate was Canceled on the Basis Of Example 1 to Demonstrate the Synergy Between Phosphate and Guanidine)

Step (1) in Example 1 was changed as follows: 300 g of guanidine borate powder and 15 g of silane coupling agent kH570 were weighed and dissolved in 80 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material. The remaining steps were maintained unchanged.

### Comparative Example 2: (Guanidine was Canceled on the Basis of Example 1 to Demonstrate the Synergy Between Phosphate and Guanidine)

Step (1) in Example 1 was changed as follows: 300 g of ammonium polyphosphate and 15 g of silane coupling agent kH570 were weighed and dissolved in 80 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material. The remaining steps were maintained unchanged.

### Comparative Example 3: (Aluminum Hydroxide was Added to a Flame Retardant Composition of a Capsule Core on the Basis of Example 1 to Demonstrate that the Addition Of Aluminum Hydroxide to the Capsule Core Did not Achieve a Synergistic Effect)

(1) 150 g of guanidine borate powder, 150 g of ammonium polyphosphate, and 100 g of aluminum hydroxide were weighed and pre-mixed in a sand mill mixer for 1 hour. 15 g of silane coupling agent kH570 was weighed and dissolved in 80 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material.

(2) 8 g of methyl methacrylate and 8 g of 1,4-butanediol dimethacrylate were weighed, stirred uniformly and then added to the first material, a solution including 0.2 g of azobisisobutyronitrile and 20 g of mineral oil was further added to the first material to obtain a mixture, which was then heated to 40 DEG C. and continuously stirred for 20 minutes to obtain a second material.

(3) 8 g of sorbitan monooleate polyoxyethylene ether was weighed and added to the second material while stirring to obtain a mixture, which was then mixed well, heated to 50 DEG C., and stirred for 20 minutes to obtain a third material.

(4) 4 g of N-hydroxyethyl acrylamide was weighed and dissolved in 400 ml (60 DEG C.) deionized water to obtain a solution, and the solution was added to the third material to obtain a mixture, which was then homogenized for 10 minutes and reacted at a constant temperature of 60 DEG C. for 4 hours to obtain a fourth material.

(5) The fourth material was cooled to 45 DEG C., added with 50 g of silica sol, supplemented with deionized water until 1000 g, and stirred for 10 minutes to obtain a forest fire extinguishing agent.

### Comparative Example 4: (Aluminum Hydroxide was Added to a Capsule Shell on The Basis of Example 1 to Demonstrate that the Addition of Aluminum Hydroxide to the Capsule Shell Did not Achieve a Synergistic Effect)

(1) 150 g of guanidine borate powder and 150 g of ammonium polyphosphate were weighed and pre-mixed in a sand mill mixer for 1 hour. 15 g of silane coupling agent kH570 was weighed and dissolved in 80 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material.

(2) 8 g of methyl methacrylate and 8 g of 1,4-butanediol dimethacrylate were weighed, stirred uniformly and then added to the first material, a solution including 0.2 g of azobisisobutyronitrile and 20 g of mineral oil was further added to the first material to obtain a mixture, which was then heated to 40 DEG C. and continuously stirred for 20 minutes to obtain a second material.

(3) 8 g of sorbitan monooleate polyoxyethylene ether was weighed and added to the second material while stirring to obtain a mixture, which was then mixed well, heated to 50 DEG C., and stirred for 20 minutes to obtain a third material.

(4) 4 g of N-hydroxyethyl acrylamide, 100 g of aluminum hydroxide, and 5 g of carboxymethyl cellulose were weighed and dissolved in 400 ml (60 DEG C.) of deionized water to obtain a solution, and the solution was added to the third material to obtain a mixture, which was then homogenized for 10 minutes and reacted at a constant temperature of 60 DEG C. for 4 hours to obtain a fourth material.

(5) The fourth material was cooled to 45 DEG C., added with 50 g of silica sol, supplemented with deionized water until 1000 g, and stirred for 10 minutes to obtain a forest fire extinguishing agent.

### Comparative Example 5: (Mineral Oil was Canceled on the Basis of Step (2) in Example 2 to Demonstrate that the Flame Retardant had Poor Effect and Precipitated During Later Storage)

(1) 150 g of guanidine carbonate and 100 g of ammonium polyphosphate were weighed and pre-mixed in a sand mill mixer for 1 hour. 25 g of silane coupling agent kH550 was weighed and dissolved in 100 ml of dichloromethane to obtain a solution, which was then dripped into a stirred flame retardant for 30 minutes. A sand mill heater was started, and the system was maintained at a constant temperature of 45 DEG C. and continuously stirred for 30 minutes to evaporate the solvent and obtain a modified first material.

(2) 80 g of glycidyl methacrylate and 1 g of dibenzoyl oxide were weighed and mixed uniformly to the first material to obtain a mixture, which was further mixed uniformly, heated to 50 DEG C., and continuously stirred for 20 minutes to obtain a second material.

(3) 10 g of sodium dodecyl sulfate was weighed and stirred into the second material to obtain a mixture, which was then mixed well, heated to 50 DEG C., and stirred for 20 minutes to obtain a third material.

(4) 50 g of acrylonitrile, 100 g of aluminum hydroxide, and 5 g of sodium carboxymethyl cellulose were weighed and dissolved in 400 ml (60 DEG C.) of deionized water to obtain a solution, and the solution was added to the third material to obtain a mixture, which was then homogenized for 10 minutes and reacted at a constant temperature of 60 DEG C. for 4 hours to obtain a fourth material.

(5) The fourth material was cooled to room temperature, added with 40 g of silica nanopowder, supplemented with deionized water until 1000 g, and stirred for 10 minutes to obtain a forest fire extinguishing agent.

### Experiment 1 Test on the Flame Retarding Effects of Guanidine Salt Flame Retardants

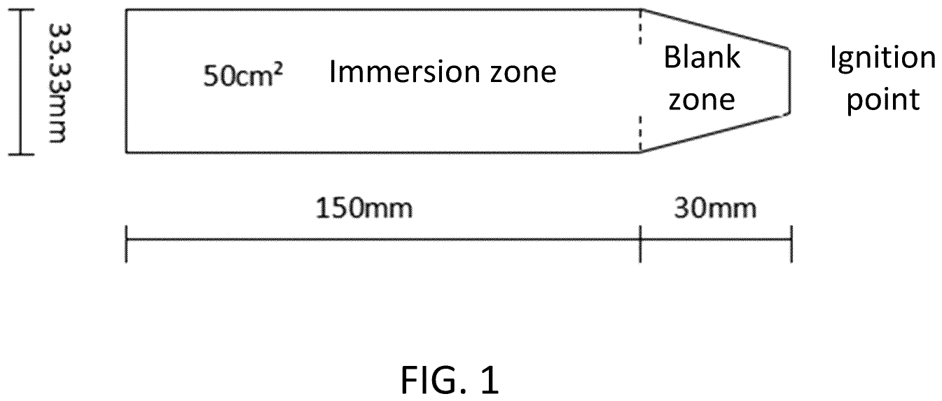

Preparation for the test: Newspaper was cut into a 180 mm long×33.33 mm wide rectangle, and a 30 mm high isosceles trapezoid was cut along oblique lines at 150 mm on long sides, as shown in FIG. 1.

The prepared paper strip was put into a constant temperature drying oven and dried at 40 DEG C. for 4 hours for later use.

Each guanidine flame retardant was dissolved in deionized water to form a solution with a content of 5 wt %. An immersion zone of the test paper strip was immersed in the solution for 10 seconds, and the test paper strip was taken out, hung indoors, dried in air for 48 hours, and then dried in the oven at 40 DEG C. for 4 hours to obtain a test paper strip with a trapezoidal zone as a blank agent-free control zone.

A candle was lighted, and the trapezoidal agent-free zone was aligned with a candle flame to ignite the test paper strip. An unburned area was accurately measured to calculate a flame retarding percentage. Flame retarding percentages of guanidine flame retardants are shown in Table 1 below:

TABLE 1
Flame retarding percentages of guanidine flame retardants

| | | Immersion | | Flame |
|---|---|---|---|---|
| Name of | Concentration | area of | Unburned | retarding |
| flame | of aqueous | paper | area | percentage |
| retardant | solution (%) | strip (cm²) | (cm²) | (%) |
| Guanidine | 5 | 50 | 35.2 | 70.40 |
| borate | | | | |
| Guanidine | 5 | 50 | 31.6 | 63.20 |
| sulfate | | | | |
| Guanidine | 5 | 50 | 33.4 | 66.80 |
| carbonate | | | | |
| Guanidine | 5 | 50 | 38.8 | 77.60 |
| phosphate | | | | |
| Polymeric | 5 | 50 | 42.6 | 81.20 |
| guanidine | | | | |

### Experiment 2 Test on the Flame Retarding Effects of Forest Fire Extinguishing Agents

The forest fire extinguishing agents prepared in Examples 1-5 and Comparative Examples 1-5 were diluted with 20 times water. 10 test paper strips, the same as those used in Experiment 1, were respectively immersed in the drug-treated area in the above-diluted forest fire extinguishing agents for 10 seconds, and the test paper strips were taken out, hung indoors, dried in air for 48 hours, and then dried in an oven at 40 DEG C. for 4 hours to obtain test paper strips with trapezoidal zones as blank agent-free control zones.

A candle was lighted, and the trapezoidal agent-free zone was aligned with a candle flame to ignite the test paper strip. Unburned areas were accurately measured to calculate the flame retarding percentages of the forest fire extinguishing agents prepared in Examples 1-5 and Comparative Examples 1-5. The test results are shown in Table 2.

TABLE 2
Different proportions and flame retarding effects
of flame retardants

| | Immersion | | Flame |
|---|---|---|---|
| Example/ | zone of | Unburned | retarding |
| Comparative | paper | area | percentage |
| Example | strip (cm²) | (cm²) | (%) |
| Example 1 | 50 | 42.8 | 85.6 |
| Example 2 | 50 | 45.1 | 90.2 |
| Example 3 | 50 | 43.3 | 86.6 |
| Example 4 | 50 | 46.8 | 93.6 |
| Example 5 | 50 | 46.5 | 93.0 |
| Comparative Example | 50 | 37.5 | 75.0 |
| 1 | | | |
| Comparative Example | 50 | 39.2 | 78.4 |
| 2 | | | |
| Comparative Example | 50 | 42.5 | 85.0 |
| 3 | | | |
| Comparative Example | 50 | 46.3 | 92.6 |
| 4 | | | |
| Comparative Example | 50 | 45.3 | 90.6 |
| 5 | | | |

Their stability was further tested: The forest fire extinguishing agents of Examples 1-5 and Comparative Examples 1-5 were stored in a warehouse at a temperature of 15 DEG C.-30 DEG C. day and night for 2 months. After storage, whether different forest fire extinguishing agents were stratified and precipitated was observed. Among them, the forest fire extinguishing agent of Comparative Example 5 showed massive precipitates at the bottom of a storage container, while Example 5 showed powder precipitates. The other examples and comparative examples showed good stability and no obvious precipitates.

### Experiment 3 Test on Fire Extinguishing Effect

### Preparation

A: Wooden strips, specification: square cross-section, side length 40 mm, wooden strip length 500 mm. Quantity of wooden strips: 72. Moisture content of wooden strips <10%.

B: Wooden strips were stacked on a metal rack, with a total height of 400 mm, 8 strips per layer, and a total of 9 layers.

C: The ignition agent was 1500 ml of 120 #solvent oil contained in a square metal tray with a side length less than that of the wooden stack. 30 mm deep water was added into the metal tray. An oil solvent was ignited, and the metal tray was removed after the oil solvent was burnt out.

D: After the wooden stack was ignited, the wooden strips burned freely. When their mass was less than 53% of the original mass, the pre-combustion ended.

E: A 6.6 L fire extinguisher was filled with the forest fire extinguishing agent diluted 20 times with water, its spray valve was opened at a distance of 1.8 meters from the wooden stack, and the fire extinguishing agent was sprayed from the top, bottom, and sides towards the wooden stack to extinguish the fire.

5 identical wooden stacks were set up, and each stack was subjected to the fire extinguishing experiment using the forest fire extinguishing agents from Examples 1-5. The experimental results were as follows: After the forest fire extinguishing agents were sprayed, the flames of all the 5 wooden stacks were extinguished, and there was no after-combustion within 10 minutes.

According to the national standard, they achieved a 2A fire extinguishing effect.

### Test on Toxicity

The toxicity of the forest fire extinguishing agents of Examples 1-5 was tested as follows: Zebrafish was normally fed for 96 hours with the forest fire extinguishing agents diluted 20 times with water, showing no one died. Conclusion: The toxicity of the fire extinguishing agents was zero.

Freezing point test result: The freezing points of the forest fire extinguishing agents were between −19 DEG C. and −20 DEG C..

Corrosion rate test result: The corrosion rate was less than 0.9 mdd (milli-daily dose).

A method of using the forest fire extinguishing agent in the present application was as follows:

The forest fire extinguishing agent was diluted 10-20 times with water for spraying. The forest fire extinguishing agent was sprayed with a seaplane 500 m away from a downwind area of a fire zone to create a 50-100 m wide fire-resistant and flame-retardant isolation zone, then sprayed against a canopy fire, and finally sprayed against a ground fire. In addition to the seaplane, ground fire-fighting vehicles, fire-fighting armored vehicles, and manually carried small spraying devices can also be used.

The specific examples in the present application are only for the explanation of the present application and do not limit the present application. After reading the description, those skilled in the art can make modifications to the examples as needed without creative contributions, and these modifications are protected by the Patent Law as long as they fall within the scope of the claims of the present application.

What is claimed is:

1. A method for preparing a forest fire extinguishing agent, comprising the following steps:
(1) mixing a first flame retardant and a coupling agent uniformly to obtain a first material;
(2) stirring a hydrophobic polymer monomer or a hydrophobic polymer monomer and an initiator into the first material uniformly to obtain a second material;
(3) stirring a surfactant into the second material to obtain a mixture before heating the mixture to obtain a third material;
(4) obtaining a fourth material by adding a solution comprising a hydrophilic polymer and water to the third material, applying a homogenization treatment to the third material with the solution added, heating and stirring the third material with the solution added, and letting the third material and the solution react under a constant temperature; and
(5) cooling the fourth material before stirring a flame retardant additive and water uniformly into the fourth material to obtain the forest fire extinguishing agent.

2. The method for preparing the forest fire extinguishing agent according to claim 1, wherein in step (1), the first flame retardant is at least one of a guanidine salt flame retardant, an ammonium salt flame retardant, or a phosphorus-based flame retardant.

3. The method for preparing the forest fire extinguishing agent according to claim 2, wherein the dosage of the guanidine salt flame retardant is 5-30 parts by weight, the dosage of the phosphorus-based flame retardant is 5-35 parts by weight, and the dosage of the ammonium salt flame retardant is 5-25 parts by weight.

4. The method for preparing the forest fire extinguishing agent according to claim 1, wherein in step (2), the initiator is added to an oil-based carrier to obtain a mixture, which is then added to the first material.

5. The method for preparing the forest fire extinguishing agent according to claim 1, wherein a second flame retardant is added to a reaction product of the third material and the solution in step (4), and the second flame retardant is a metal hydroxide flame retardant, with a dosage of 2-15 parts by weight.

6. The method for preparing the forest fire extinguishing agent according to claim 1, wherein the coupling agent is selected from one or more of a tetrabutyl titanate, an aluminate ester, a silane coupling agent, a phosphate coupling agent, or a borate coupling agent, and the dosage of the coupling agent is 0.1-5.0 parts by weight.

7. The method for preparing the forest fire extinguishing agent according to claim 1, wherein:
the hydrophobic polymer monomer is selected from one or more of a methyl acrylate, an ethyl acrylate, a polybutyl acrylate, a glycidyl methacrylate, a 1,4-butanediol dimethacrylate, a methyl methacrylate, an ethyl acetoacetate methacrylate, an isophorone diisocyanate, or a toluene diisocyanate, and the dosage of the hydrophobic polymer monomer is 0.5-20 parts by weight;
a mass ratio of the initiator to the hydrophobic polymer monomer is 0.01% to 5.00%;
the surfactant is selected from one or more of a propylene glycol monolaurate, a sorbitan monostearate, a polyoxyethylene sorbitan monooleate, a sorbitan monolaurate, a sodium dodecyl sulfate, a sodium dodecyl benzene sulfonate, a diethylene glycol fatty acid ester, a sorbitan monopalmitate, a polyoxyethylene stearate, a polyoxyethylene sorbitan trioleate, or a sorbitan monooleate polyoxyethylene ether, and a ratio of the surfactant to the hydrophobic polymer monomer is (0.2-50) to 100; and
the hydrophilic polymer is selected from one or more of a polyvinyl alcohol, a polyethylene glycol, an acrylamide, a N-hydroxymethyl acrylamide, a N-hydroxyethyl acrylamide, an acrylonitrile, or a diethylenetriamine, and the dosage of the hydrophilic polymer is 0.1-10 parts by weight.

8. The method for preparing the forest fire extinguishing agent according to claim 1, wherein in step (4), a duration of the homogenization treatment is 1-60 minutes, the constant temperature for the reaction is 45 DEG C.-90 DEG C., and a duration of the reaction is 0.5-8.0 hours.

9. A forest fire extinguishing agent, wherein the forest fire extinguishing agent is prepared by the method according to claim 1.

10. A forest fire extinguishing agent, comprising a flame retardant with a core-shell structure, and a carrier, wherein
in the flame retardant with the core-shell structure, a core of the core-shell structure comprises a first flame retardant, a shell of the core-shell structure comprises a water absorbent polymer, and the first flame retardant is at least one of a guanidine salt flame retardant, an ammonium salt flame retardant, or a phosphorus-based flame retardant; and wherein the shell of the core-shell structure further comprises a metal hydroxide flame retardant.
